(19) United States
(12) Patent Application Publication
(10) Pub. No.: US 2010/0062669 A1
(43) Pub. Date: Mar. 11, 2010

(54) MULTI-COMPONENT FIBERS CONTAINING HIGH CHAIN-LENGTH POLYAMIDES

(75) Inventors: Gregory S. O'Brien, Downingtown, PA (US); John C. Chen, Malvern, PA (US)

Correspondence Address: ARKEMA INC.;PATENT DEPARTMENT - 26TH FLOOR, 2000 MARKET STREET, PHILADELPHIA, PA, 19103-3222, US

(73) Assignee: Arkema Inc., Philadelphia, PA (US)

(21) Appl. No.: 12/514,710

(22) PCT Filed: Oct. 24, 2007
(86) PCT No.: PCT/US07/82330

§ 371 Date: May 13, 2009

Related U.S. Application Data
(60) Provisional application No. 60/858,815, filed on Nov. 14, 2006.

(51) Int. Cl. D03D 15/00; C08L 77/06; D02G 3/22; D02G 3/02; D04H 13/00

(52) U.S. Cl. 442/201; 525/420; 428/401; 428/400; 442/347

(57) ABSTRACT

This invention relates to multi-component fibers made of at least 40 weight percent, and preferably over 50 weight percent of one or more high chain length polyamides. The fibers have both a high tear strength and good tensile strength. The fibers can be used to produce woven and non-woven articles having excellent toughness.

### FIELD OF THE INVENTION

This invention relates to multi-component fibers made of at least 40 weight percent, and preferably over 50 weight percent of one or more high chain length polyamides. The fibers have both a high tear strength and good tensile strength. The fibers can be used to produce woven and non-woven articles having excellent toughness.

### BACKGROUND OF THE INVENTION

Thermoplastic resins have been extruded into synthetic fibers for many years, and have been used to produce both woven and non-woven materials. More recently, multi-component fibers composed of two or more incompatible polymers have been introduced for this use.

Multi-component fibers are often referred to as “conjugate fibers” or “fibrillatabled” fibers. They contain two or more components that are often incompatible. Multi-component fibers are a means of combining the properties of different thermoplastics into a single fiber. The components of the fiber make up many separate continuous microfibrils running the length of the fiber. The individual fibrils can take many shapes, including wedges, pie-shapes, side-by-side, sheath-core, core-sheath, bi-lobal or multi-lobal. In a cross section of the fiber, each microfibril appears as a non-continuous phase. In one arrangement, often described as “islands in the sea”, many microfibrils, often from 10 to 500, constitute non-continuous individual round or ovoid fibrils in a continuous phase of a second polymer.

The multi-component fibers are typically produced by simultaneously and continuously extruding a plurality of molten polymers through spinning orifices of a spinneret to form multiple fibril strands.

U.S. Pat. No. 5,534,335 describes a multi-component fiber made of two incompatible polymers—including a continuous polyolefin phase, and a discontinuous phase of up to 5 weight percent of polyamide 6, polyamide 11, or polyamide 12. A compatibilizer, such as an maleic acid/anhydride modified polypropylene is present in the multi-component fiber.

U.S. Pat. No. 6,200,669 describes many shapes and methods for producing splittable multi-component fibers. The purpose of the invention is to split the multi-component fiber in many individual segments that are partially exposed at the surface of the multi-component fiber. The multi-component fibers include those of polyolefins, and polyamides like nylon-6. The fibers are bonded and then entangled by processes such as hydroentangling in which the individual components become separated from the multi-component fiber and become entangled to form non-woven webs. The reference discloses the matching of viscosities of each component during processing to prevent processing difficulties.

One problem with synthetic fibers currently available, including multi-component fibers, is that the fibers and woven/non-woven materials formed from the fibers lack the toughness needed in many applications. In particular they show a limited tear strength and tensile strength. Current offerings do not deliver both high tensile strength and high tear strength.

Surprisingly it has been found that multi-component fibers containing a large percentage of high-chain length polyamide components have both a high tear strength and a high strength in both the fiber and materials formed from the fibers.

### SUMMARY OF THE INVENTION

The invention relates to tough multi-component fibers made of
a) At least 40 weight percent or greater of one or more high chain-length polyamides having a polyamide chain length of greater than 6; and
b) less than 60 weight percent of one or more other thermoplastic polymers having a melting point lower than that of said high chain-length polyamides.

The invention also relates to woven and non-woven materials made from these multi-component fibers, as well as to articles made for the woven or non-woven materials.

### DETAILED DESCRIPTION OF THE INVENTION

The invention relates to multi-component fibers of which a majority of the fiber by weight is made of one or more high chain length polyamides. The fibers are tough and have good tensile strength and tear resistance. The fibers can be used to produce woven and non-woven articles having excellent toughness.

A multi-component fiber, as used herein, refers to a fiber composed of 2 or more thermoplastic polymer materials. At least 40 percent by weight of the fiber, and preferably more than 50 percent by weight of the fiber, is composed of one or more high-chain length polyamides. The multi-component fiber may take any of the morphologies known in the art for multi-component fibers, such as, but not limited to, wedges, pie-shapes, side-by-side, sheath-core, core-sheath, bi-lobal, and multi-lobal morphologies. In one preferred embodiment, the fiber has an “islands in the sea” type of morphology, whose cross-section is made of many small “islands” of a non-continuous phase, high chain-length polyamides that are dispersed in a continuous phase of a lower melting point matrix polymer(s). The “islands” of high chain length polyamide exist as continuous microfibrils extending the length of the fiber. The polyamide microfibrils have an average diameter in the range of from 1 to 5000 nm, and preferably 300 to 2300 nm. The multi-component fiber has an average diameter in the range of 5,000 to 30,000 nm, and preferably 8,000 to 16,000 nm depending on the process and intended end use. The number of microfibils in the fiber can range from 10 to 1000, preferably 100 to 200, depending on the process and fiber diameter.

The microfibrils may have any shape, including square, round, and wedge-shaped. In a preferred embodiment, the shapes have no sharp edges. Thus round ovoid and “amoeba”-type shapes are preferred over wedges, rectangles, triangles and other sharp edged morphologies. While not being bound by any particular theory, it is believed that sharper edges lead to stress concentration points during use, and will lead to fibers having less tear and tensile strength.

The high-chain length polyamides of the invention are those polyamides or copolyamides having amide chain lengths greater than 6 and preferably greater than 10. Examples of high chain length polyamides of the invention include, but are not limited to: polyamide 11, polyamide 12, polyamide 14, polyamide 12,12, polyamide 6,12, polyamide 6,10, polyamide 6,14, polyamide 10,10, polyamide 10,12, polyamide 6,18, and mixtures thereof. Some blends especially useful in the present invention include, but are not limited to PA 6,14 with PA 11.

While not being bound by any particular theory, it is believed that the longer chain length polyamides provide greater toughness due to increased molecular weight and greater propensity for chain orientation and/or entanglement, and higher ductility even at low relative humidity and/or low moisture content in the polymer.

The high chain-length polyamide microfibrils of the invention make up more than 40 percent by weight of the multi-component fiber, and preferably more than 50 weight percent. Fibers with greater than 60 weight percent, and even over 70 weight percent are also preferred embodiments.

The molecular weight of the polyamide can be in the range of 5000 to 50,000 g/mol. In one preferred embodiment, the polyamide is of lower molecular weight (10,000 to 30,000 g/mol) to provide a lower viscosity material. High molecular weight polyamides can lead to an increase in viscosity that may produce a higher head pressure in the extruder. Additionally, it is advantageous for ease of processing that the viscosities of the different components of the multi-component fiber have similar viscosities at the processing temperature.

The thermoplastic component of the multi-component fiber that is not the high chain length polyamide component(s) makes up 60 percent by weight or less of the fiber. This second phase has a melting point lower than that of the high chain length polyamide microfibrils. Preferably the second phase melting point is at least 10° C., more preferably 20° C. and most preferably 40° C. less than that of the polyamide microfibrils.

Examples of thermoplastic polymers useful as the lower melting point component include, but are not limited to polyesters such as polyethylene terephthalate (PET), polybutylene terephthalate (PBT); polylactide; polylactic acid; polyolefins including polyethylene PE (high density PE, linear low density PE), polypropylene, co-polyolefins; polystyrene; polyurethanes; acetals; poly(methyl)methacrylate; polyethylene vinyl alcohol; polyvinyl alcohol; polyvinyl chloride; polyvinylidene chloride; polyether block polyamide; polycarbonate; polyimides; polysulfones; polysaccharides such as starch and cellulose; polycaprolactone; polyamides having lower chain lengths, such as polyamide 6 and polyamide 6/6;copolymers of ethylene with methylacrylate, butyl acrylate, maleic anhydride, glycidyl methacrylate, vinyl acetate, and alloys and copolymers of these polymers.

In one embodiment, a tough multi-component bio-fiber can be made using polyamide 11 with polylactide or polylactic acid or their copolymers.

A compatibilizer may be used in forming the multi-component fiber. Useful compatibilizers include, but are not limited to, maleic anhydride/polypropylene copolymer, maleic anhydride/methylmethacrylate block copolymer, maleic acid/methylmethacrylate block copolymer, maleic anhydride/styrene/methylmethacrylate block copolymer, polyethylene methacrylic acid copolymers (including but not limited to ionomer resins partially neutralized with zinc cations). In a preferred embodiment, no compatibilizer is required to form the multi-component fiber.

Multi-component fibers can be formed by means known in the art, such as by simultaneously and continuously extruding a plurality of molten polymers through spinning orifices of a spinneret to form multiple fibril strands. Electro spinning (as described in US 2006/0057350) can also be used to form the multi-component fibers.

Multi-component fibers of the invention have an improved toughness compared to other multi-component fibers. The improved toughness is seen as a combination of higher tensile strength, higher tear strength and grab strength.

Components of the multi-component fibers of the invention are capable of being separated or extracted, by dissolving or otherwise removing the continuous phase to leave the micro-fibrils. In a preferred embodiment, the fiber is not separated into separate micro-fibrils, but the fiber is used as a multi-component fiber.

The multi-component fibers of the invention may be used in forming non-woven webs, woven fabrics, yarn, packaging, felt, carpeting, woven fabric, knitted fabric, and synthetic leather.

Non-woven webs formed from the multi-component fibers of the invention may be formed by means known in the art, such as spun bond, and melt-blown. The webs may also include single component polymer fibers, or with natural fiber materials such as cotton blended with the multi-component fibers.

The non-woven webs are then bonded by one or more methods known in the art, such as heating, calendaring, chemical binders, needle punching, or hydroentanglement.

In one embodiment, a non-woven web is formed by a spun-bond process, followed by hydroentanglement.

The non-woven web is then optionally finished using one or more techniques known in the art, such as dyeing, printing, sanding, and embossing. The non-woven web can be formed into useful articles such as disposable clothing, uniforms, wipes, tarps, filters, tents, packs, bags, straps, etc.

In addition to excellent mechanical properties, the higher chain-length polyamides are also known for chemical resistance flexibility and impact strength.

### EXAMPLES

### Examples 1

Nonwoven fabrics were produced by means of hydroentanglement using multi-component fibers having an islands in the sea morphology with about 108 individual microfibrils (islands). Example 1a is made of 75 weight percent polyamide 11 and 25 weight percent of polyethylene. Comparative example 1b is composed of 75 weight percent polyamide 6 and 25 weight percent polyethylene, with the same number of islands, polymer ratio, and number of passes through the hydroentangling machine as example 1a. tear strength and grab strength were measured and are reported in terms of both machine Direction (MD) and Cross Direction (CD) in Table 1.

TABLE 1

| | |
|---|---|
| Tear Tongue Strength, lb | Grab |

| Ex | MD | CD | MD | CD |
|---|---|---|---|---|
| 1a | 16.5 | 26.9 | 201 | 127 |
| 1b (comp) | 10.0 | 14.1 | 218 | 70.1 |

The data indicate that multi-component fibers made with polyamide 11 provides improved tear strength (65% improvement in Machine Direction (MD), 91% in Cross Direction (CD)) and grab strength (81% improvement in CD) compared to comparable fabrics containing PA-6/PE (75/25 ratio).

1. A tough multi-component fiber comprising:
a) 40 weight percent or greater of one or more high chain-length polyamides having a polyamide chain length of greater than 6; and
b) less than 60 weight percent of one or more other thermoplastic polymers having a melting point lower than that of said high chain-length polyamides.

2. The multi-component fiber of claim 1, wherein said high chain-length polyamide comprises one or more polyamides selected from the group consisting of polyamide 11, polyamide 12, polyamide 14, polyamide 12,12, polyamide 6,12, polyamide 6,10, polyamide 6,14, polyamide 10,10, polyamide 10,12, and polyamide 6,18.

3. The multi-component fiber of claim 1, wherein said fiber has an average diameter of from 5,000 to 30,000 nm.

4. The multi-component fiber of claim 1, wherein said fiber comprises at least 50 weight percent of said high chain-length polyamide.

5. The multi-component fiber of claim 4, wherein said fiber comprises at least 60 weight percent of said high chain-length polyamide.

6. The multi-component fiber of claim 5, wherein said fiber comprises at least 70 weight percent of said high chain-length polyamide.

7. The multi-component fiber of claim 1, wherein the weight average molecular weight of said high chain-length polyamide is from 5000 to 50,000 g/mol.

8. The multi-component fiber of claim 1, comprising about 75 weight percent of polyamide 11 or polyamide 12 and 25 weight percent of polyethylene.

9. The multi-component fiber of claim 1 wherein said fiber has an islands in the sea morphology having in cross-section of said fiber high chain-length polyamides as non-continuous microfibrils and said other thermoplastic as the continuous phase.

10. The multi-component fiber of claim 8, wherein said high chain-length polyamide microfibrils have an average cross sectional diameter of from 1 to 5000 nm.

11. The multi-component fiber of claim 9, wherein each fiber contains from 32-240 microfibrils.

12. A woven or non-woven material comprising the tough multi-component fiber of claim 1.

13. The woven or non-woven material of claim 10 comprising non-woven webs, woven fabrics, yarn, packaging, felt, carpeting, woven fabric, knitted fabric, synthetic leather

14. The woven or non-woven material of claim 10, comprising a non-woven web wherein said fibers are hydroentangled, or thermally bonded at lower temperatures to maintain the long chain polyamide crystallinity.

15. An article comprising the woven or non-woven material of claim 12.

16. The article of claim 15 comprising disposable clothing, uniforms, wipes, tarps, filters, tents, packs, bags, or straps.
